(19) United States
(12) Patent Application Publication
(10) Pub. No.: US 2014/0222201 A1
(43) Pub. Date: Aug. 7, 2014

(54) DIRECTIONAL POSITION CONTROL METHOD

(71) Applicant: HIWIN TECHNOLOGIES CORP., Taichung City (TW)

(72) Inventors: Wen-Chia WU, Taichung City (TW); Yan-Yu CHEN, Taichung City (TW)

(73) Assignee: HIWIN TECHNOLOGIES CORP., Taichung City (TW)

(21) Appl. No.: 13/757,799

(22) Filed: Feb. 3, 2013

(51) Int. Cl. G06F 17/00

(52) U.S. Cl. CPC G06F 17/00
USPC 700/258; 700/245; 901/2; 901/14; 901/46

(57) ABSTRACT

A directional position control method uses an instructor device and a controller to control motion of a robot, and a directional-control starter is used to actuate a directional control function. The directional-control starter controls the controller to drive the robot to move according to the instructor direction reference by converting the coordinate of the robot into the coordinate of the instructor. The directional position control method allows the movement direction reference of the robot to be defined manually or automatically, so that the robot can be moved based on the instructor direction reference of the instructor, allowing the operator to operate the robot by intuition without too much discretion, consequently reducing difficulty and error in operating the robot. Besides, the operator can control the robot by staying at the location where the instructor is located, without standing close to the robot, therefore, improving safety of operating the robot.

### BACKGROUND OF THE INVENTION

1. Field of the Invention

The present invention relates to a control method, and more particularly to a directional position control method.

2. Description of the Prior Art

FIGS. 1 and 2 illustrate a conventional method to control a robot, wherein an instructor 10 gives instructions, and the robot 20 moves along a robot direction reference F2 according to the instructions given by the instructor 10. The robot direction reference F2 includes a forward direction F21, a backward direction F22, a leftward direction F23 and a rightward direction F24.

The instructor 10 has an instructor direction reference F1 which includes a forward direction F11, a backward direction F12, a leftward direction F13 and a rightward direction F14. As shown in FIG. 1, when the instructor direction reference F1 is consistent with the robot direction reference F2 (which means that the forward direction F11 of the instructor and the forward direction F21 of the robot are in the same direction, the backward direction F12 of the instructor and the backward direction F22 of the robot are in the same direction, the leftward direction F13 of the instructor and the leftward direction F23 of the robot are in the same direction, the rightward direction F14 of the instructor and the rightward direction F24 of the robot are in the same direction), the instruction given by the instructor 10 will be the same as the movement direction of the robot 20.

However, the robot 20 keeps moving, when it moves in a direction which is inconsistent with the direction reference of the instructor 10, as shown in FIG. 2, the forward direction F11 of the instructor 10 has become the same as the rightward direction F24 of the robot 20. Under this circumstance, the operator usually operates the robot with the same direction reference as the instructor 10, so that, when the operator operates the instructors 10, he/she will believe that the robot 20 will move according to the instructor direction reference F1. However, the fact is that the robot 20 will be unable to move according to the instructor direction reference F1 when the instructor direction reference F1 is deferent from the robot direction reference F2. As a result, the operator has to detect the robot direction reference F2 before operating the instructor 10 and is unable to operate the robot by intuition, which causes difficulties and inconveniences in operating the robot.

The present invention has arisen to mitigate and/or obviate the afore-described disadvantages.

### SUMMARY OF THE INVENTION

The primary objective of the present invention is to provide a directional position control method which allows the user to operate a robot easily by intuition.

To achieve the above objective, a directional position control method uses an instructor device and a controller to control motion of a robot, and a directional-control starter is used to actuate a directional control function.

The instructor includes a control unit, the instructor defines an instructor direction reference which synchronously changes along with motion of the instructor.

The controller is signal-connected to the robot, the robot is driven to move by a drive source which is controlled by the controller, at one end of the robot is provided an end effector which is driven to move by a robot.

The directional-control starter allows an operator to start the directional control function and is signal-connected to the instructor and the controller;

The directional position control method comprising the following steps:

starting, the operator uses the directional-control starter to start the directional control function;

giving instruction by operating the control unit of the instructor;

control and motion, the directional-control starter controlling the controller to drive the robot to move according to the instructor direction reference.

### BRIEF DESCRIPTION OF THE DRAWINGS

FIG. 1 is an illustrative view showing the movement of a robot which is controlled by a conventional instructor;

FIG. 2 is another illustrative view showing the movement of a robot which is controlled by a conventional instructor;

FIG. 3 is a schematic view showing a directional position control method in accordance with a preferred embodiment of the present invention;

FIG. 4A is a side view showing an initial stage of a robot which is controlled by the directional position control method of the present invention;

FIG. 4B is a top view showing an initial stage of the robot which is controlled by the directional position control method of the present invention;

FIG. 5A is a side view showing the leftward motion of the robot which is controlled by the directional position control method of the present invention;

FIG. 5B is a top view showing the leftward motion of the robot which is controlled by the directional position control method of the present invention;

FIG. 6A is a side view showing the rightward motion of the robot which is controlled by the directional position control method of the present invention;

FIG. 6B is a side view showing the rightward motion of the robot which is controlled by the directional position control method of the present invention;

FIG. 7A is a side view showing the forward motion of the robot which is controlled by the directional position control method of the present invention;

FIG. 7B is a side view showing the forward motion of the robot which is controlled by the directional position control method of the present invention;

FIG. 8A is a side view showing the backward motion of the robot which is controlled by the directional position control method of the present invention;

FIG. 8B is a side view showing the backward motion of the robot which is controlled by the directional position control method of the present invention;

FIG. 9 shows the status of the robot of the present invention, wherein the direction reference of the instructor is different from that of the robot;

FIG. 10 shows that the robot of the present invention is controlled to move leftward by pressing the leftward-move button of the instructor;

FIG. 11 shows that the robot of the present invention is controlled to move rightward by pressing the rightward-move button of the instructor;

FIG. 12 shows that the robot of the present invention is controlled to move forward by pressing the forward-move button of the instructor;

FIG. 13 shows that the robot of the present invention is controlled to move backward by pressing the backward-move button of the instructor;

FIG. 14 shows that the robot of the present invention is controlled to move left-backward by the instructor;

FIG. 15 shows that the robot of the present invention is controlled to move right-backward by the instructor;

FIG. 16 shows an initial stage of the robot and the instructor which is controlled by the directional position control method of the present invention;

FIG. 17 is an illustrative view showing the method of setting the instructor direction reference by manual;

FIG. 18 shows that in a manual control mode, the robot is controlled to move rightward by the instructor;

FIG. 19 shows that in a manual control mode, the robot is controlled to move leftward by the instructor;

FIG. 20 shows that in a manual control mode, the robot is controlled to move forward by the instructor;

FIG. 21 shows that in a manual control mode, the robot is controlled to move backward by the instructor; and

FIG. 22 is a flow chart showing the directional position control method in accordance with the present invention.

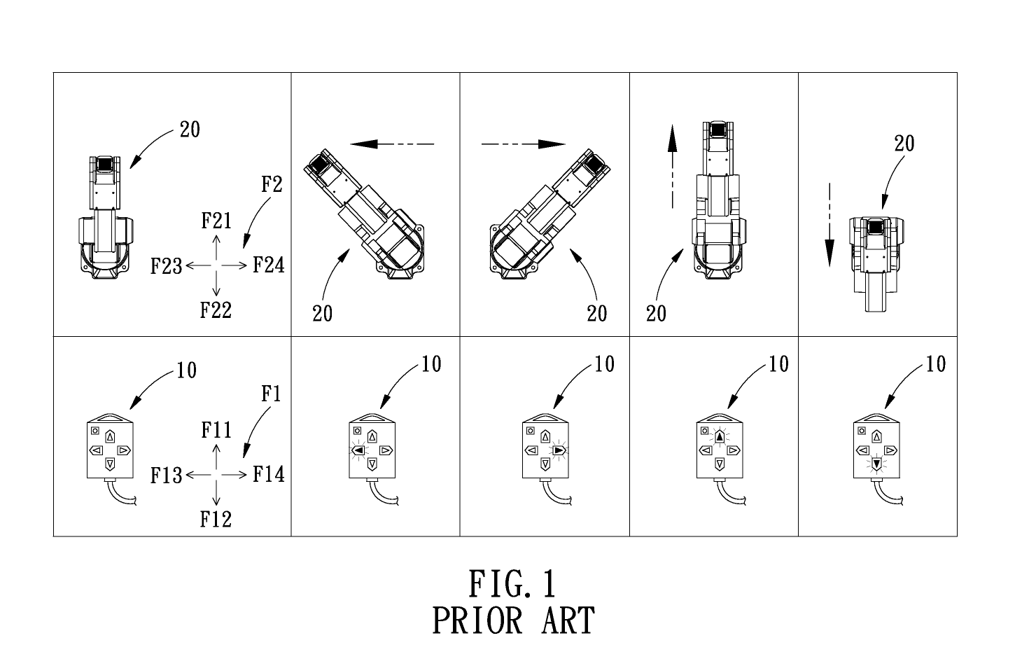

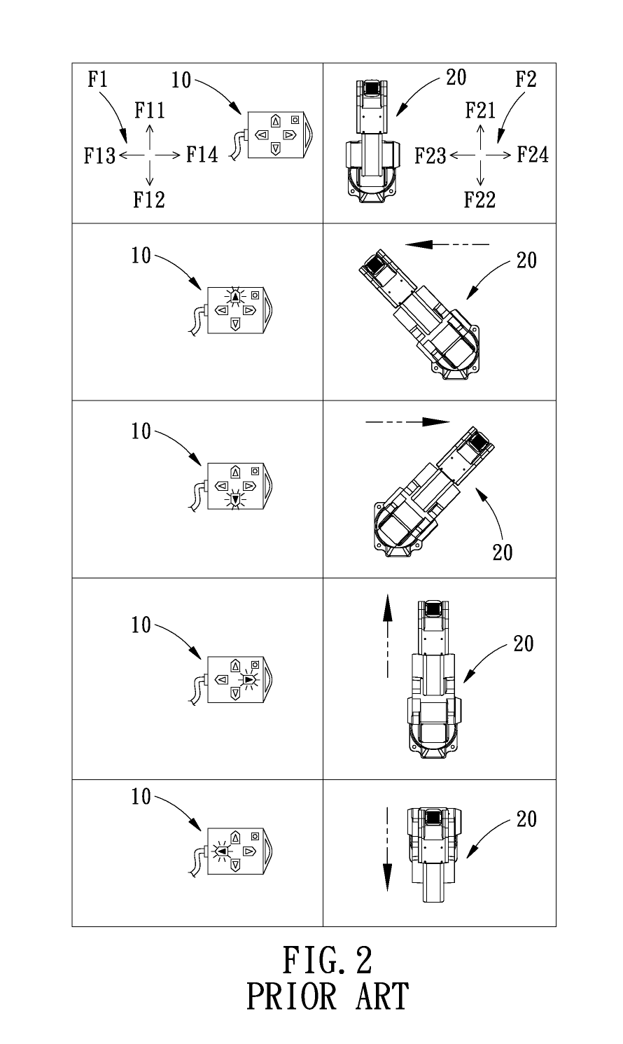

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

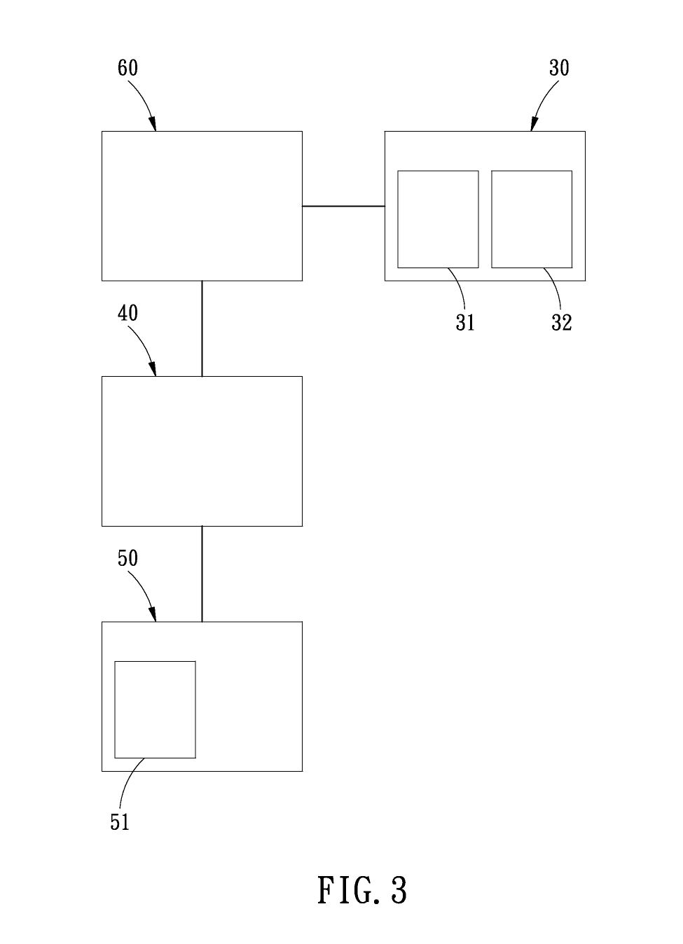

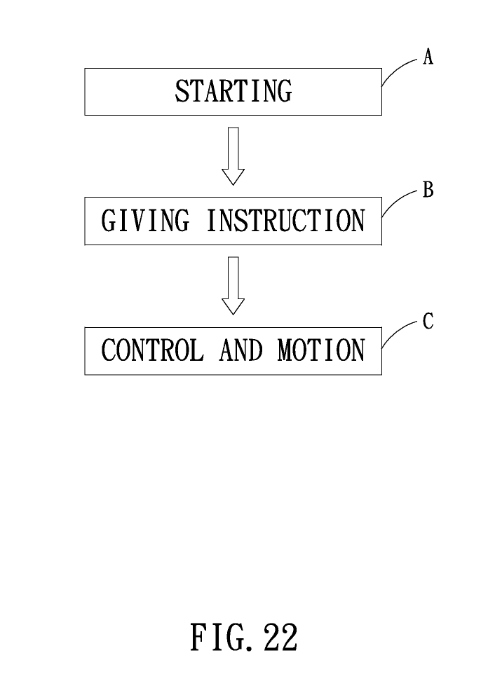

Referring to FIGS. 3-22, a directional position control method in accordance with a preferred embodiment of the present invention uses an instructor 30 and a controller 40 to control the motion of a robot 50, and a directional-control starter 60 is used to actuate the directional control function.

The instructor 30 includes a control unit 31 and a direction detector 32. The control unit 31 in this embodiment includes a forward-move button 311, a backward-move button 312, a leftward-move button 313 and a rightward-move button 314. The control unit 31 can also be a rocker and is used to control the motion of the robot 50. The instructor 30 itself has a reference direction. In this embodiment, the reference direction of the instructor 30 is such that the instructor 30 defines an instructor direction reference F3 which includes a forward direction F31, a backward direction F32, a leftward direction F33 and a rightward direction F34. The instructor direction reference F3 synchronously changes along with the motion of the instructor 30. The direction detector 32 can detect the direction and position of the instructor 30 and detect the instructor direction reference F3 of the instructor 30. The direction detector 32 can be an electronic compass, acceleration sensor or gyroscope.

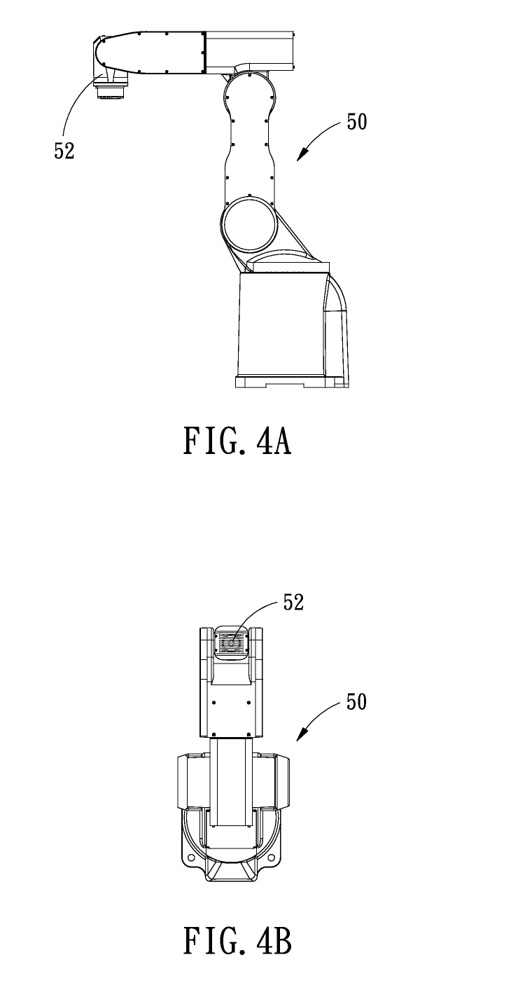

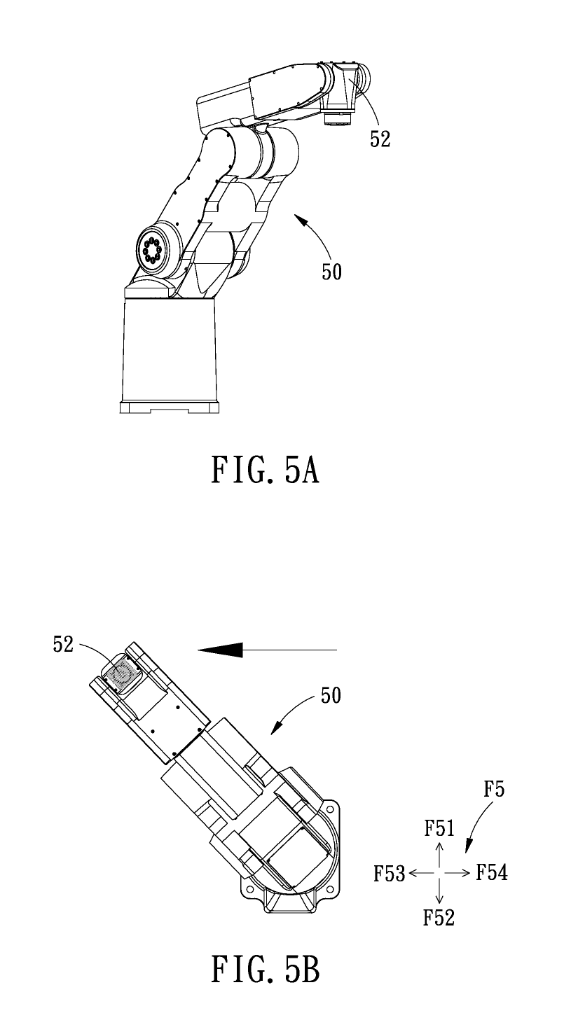

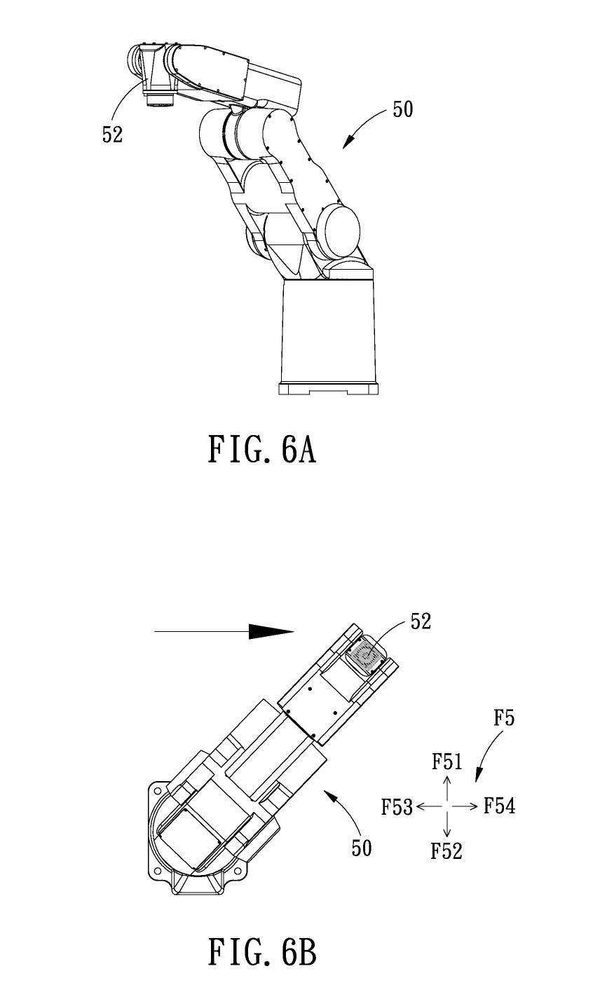

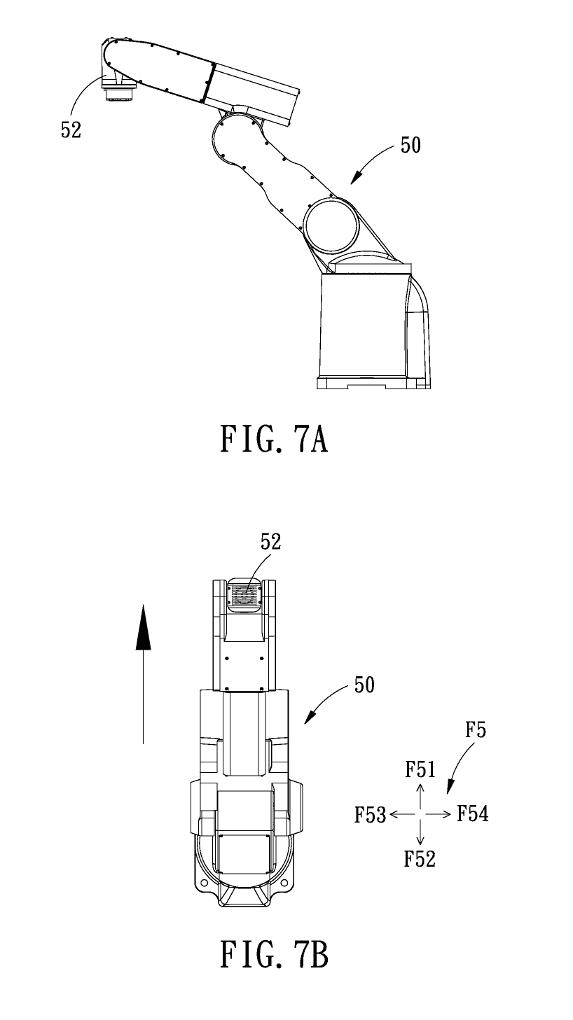

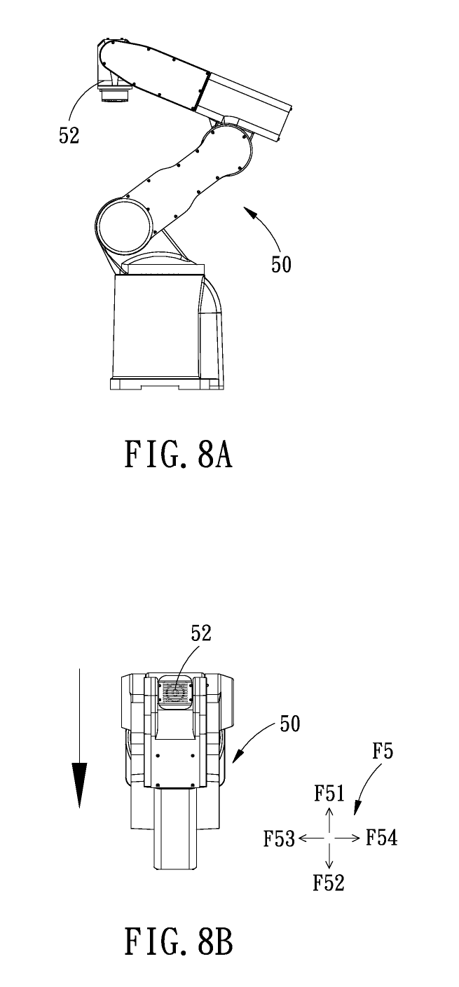

The controller 40 is signal-connected to the robot 50. The robot 50, as shown in FIGS. 4A, 4B, is a multi-axis robot, and the respective axles of the robot 50 are rotated by a drive source 51 which is controlled by the controller 40. At one end of the robot 50 is provided an end effector 52, the robot 50 defines a robot direction reference F5 which includes a forward direction F51, a backward direction F52, a leftward direction F53 and a rightward direction F54. The drive source 51 drives the robot 50 and the end effector 52 to move in the forward direction F51, the backward direction F52, the leftward direction F53 and the rightward direction F54, as shown in FIGS. 5-8. FIG. 5 shows that the robot 50 moves in the leftward direction F53; FIG. 6 shows that the robot 50 moves in the rightward direction F54; FIG. 7 shows that the robot 50 moves in the forward direction F51, and FIG. 8 shows that the robot 50 moves in the backward direction F52.

The directional-control starter 60 allows the user to selectively change the direction control into manual mode or automatic mode and is signal-connected to the instructor 30 and the controller 40. The directional-control starter 60 can be provided on the instructor 30, the controller 40 or the robot 50.

When the directional control function is actuated, the reference direction of the instructor 30 with respect to the input direction of the control unit 31 is consistent with the reference direction with respect to the direction that the end effector 52 moves.

When the direction control is set in a manual mode, the directional-control starter 60 will cooperate with the control unit 31 of the instructor 30 to set the motion direction reference of the robot 50, and the directional-control starter 60 is signal-connected to the instructor 30.

When it is set in an automatic mode, the directional-control starter 60 will receive and detect the position and direction reference of the instructor 30 to perform directional control over the robot 50. The directional control is performed by converting the coordinate of the robot 50 into the coordinate of the instructor 30.

As shown in FIG. 23, directional position control method in accordance with the present invention includes the following steps:

Starting A, the operator sets the directional-control starter 60 into manual or automatic directional control mode and starts the directional control function;

Giving instruction B: by operating the control unit 31 of the instructor 30;

Control and motion C: the directional-control starter 60 converts the coordinate of the robot 50 into the coordinate of the instructor 30, so that the controller 40 drives the robot 50 to move according to the instructor direction reference F3.

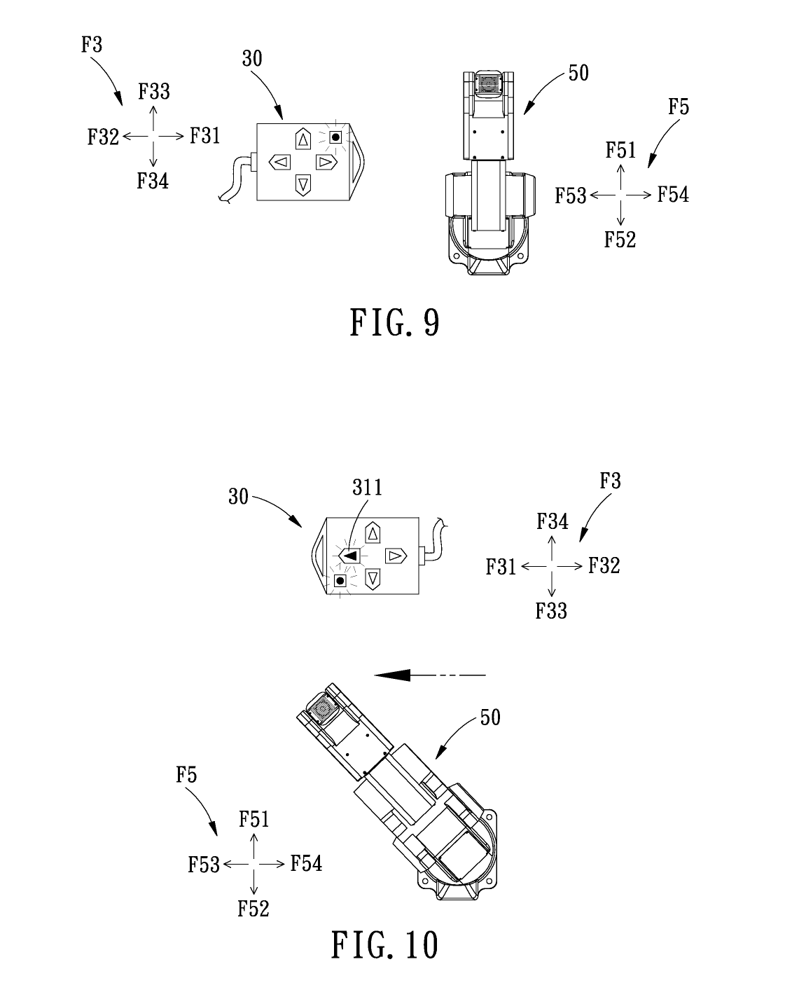

When the directional-control starter 60 is set into an automatic directional control mode, as shown in FIG. 9, and the instructor direction reference F3 is inconsistent with the robot direction reference F5, which means that the forward direction F31 of the instructor is different from the forward direction F51 of the robot 50.

When in the automatic directional control mode, the robot 50 is controlled by using the direction detector 32 to detect the instructor direction reference F3 of the instructor 30. When in the manual directional control mode, the control unit 31 is used to manually set the direction reference of the instructor 30.

As shown in FIG. 10, when the forward direction F31 of the instructor 30 is consistent with the leftward direction F53 of the robot 50, the directional-control starter 60 receives the signal from the direction detector 32 of the instructor 30 and detects the instructor direction reference F3. The directional-control starter 60 converts the robot direction reference F5 of the robot 50 into the instructor direction reference F3 of the instructor 30, so that, when the operator presses the forward-move button 311 of the instructor 30, the robot 50 will move in the forward direction F31 of the instructor direction reference F3 of the instructor 30 and toward the leftward direction F53 of the robot 50.

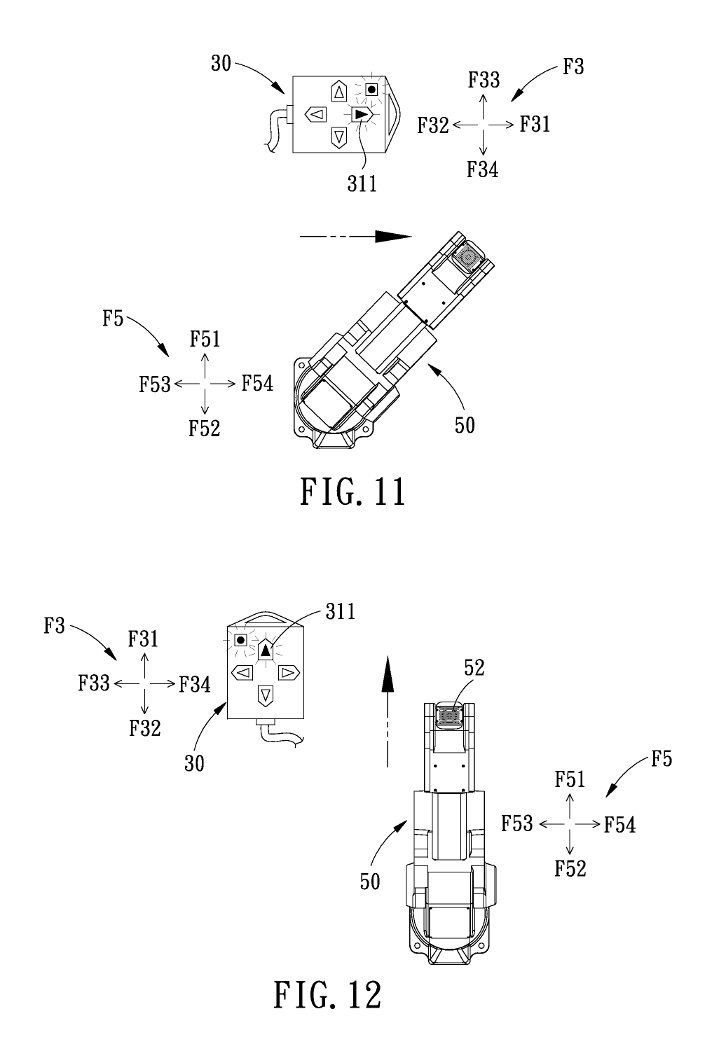

As shown in FIG. 11, when the forward direction F31 of the instructor 30 is consistent with the rightward direction F54 of the robot 50, pressing the forward-move button 311 of the instructor 30 will make the robot 50 move in the forward direction F31 of the instructor direction reference F3 of the instructor 30 and toward the rightward direction F54 of the robot 50.

As shown in FIG. 12, when the forward direction F31 of the instructor 30 is consistent with the forward direction F51 of the robot 50 and toward the instructor direction reference F3 is consistent with the robot direction reference F51, pressing the forward-move button 311 of the instructor 30 will make the robot 50 move in the forward direction F31 of the instructor direction reference F3 of the instructor 30 and toward the forward direction F51 of the robot 50.

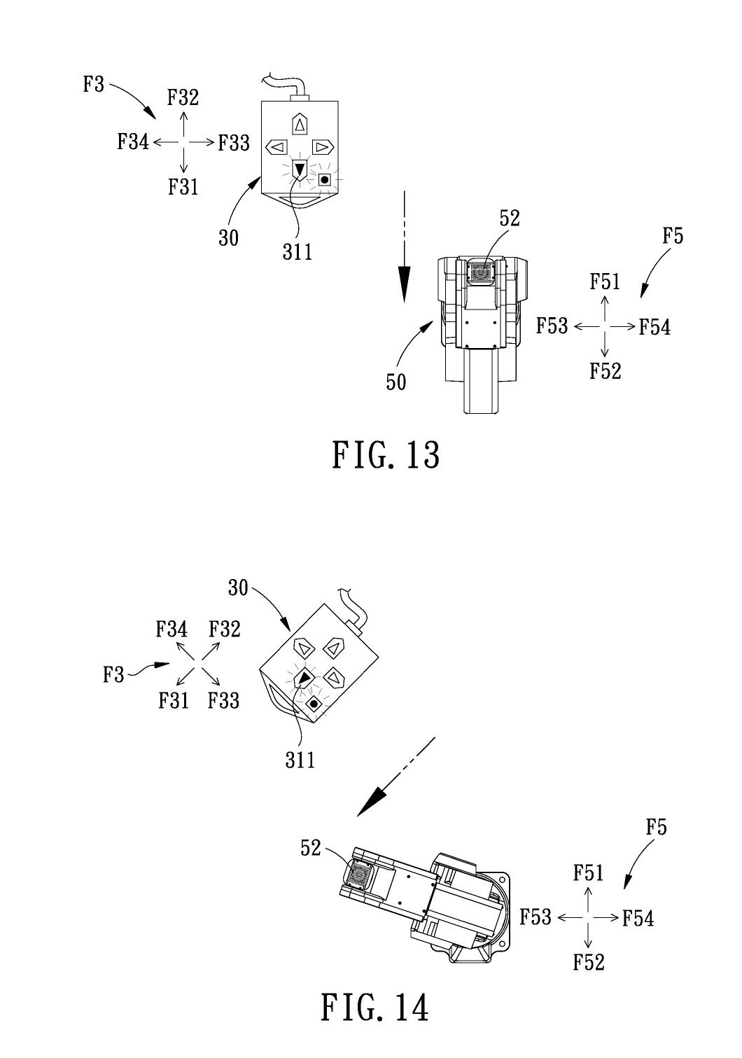

As shown in FIG. 13, when the forward direction F31 of the instructor 30 is consistent with the backward direction F52 of the robot 50, pressing the forward-move button 311 of the instructor 30 will make the robot 50 move in the forward direction F31 of the instructor direction reference F3 of the instructor 30 and toward the backward direction F52 of the robot 50.

As shown in FIG. 14, when the forward direction F31 of the instructor 30 is in the left-backward direction between the leftward direction F53 and backward direction F52 of the robot 50, pressing the forward-move button 311 of the instructor 30 will make the robot 50 move in the forward direction F31 of the instructor direction reference F3 of the instructor 30, meanwhile, the robot 50 also moves toward the leftward direction F53 and the backward direction F52 of the robot 50.

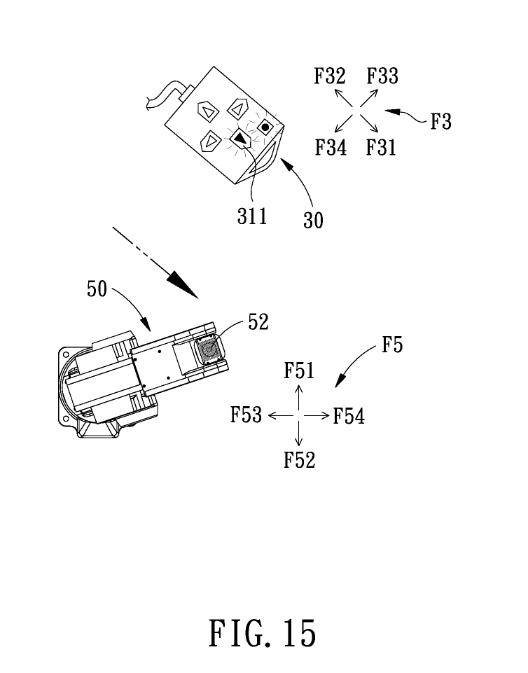

As shown in FIG. 15, when the forward direction F31 of the instructor 30 is in the right-backward direction between the rightward direction F54 and the backward direction F52 of the robot 50, pressing the forward-move button 311 of the instructor 30 will make the robot 50 move in the forward direction F31 of the instructor direction reference F3 of the instructor 30, meanwhile, the robot 50 also moves toward the rightward direction F54 and the backward direction F52 of the robot 50.

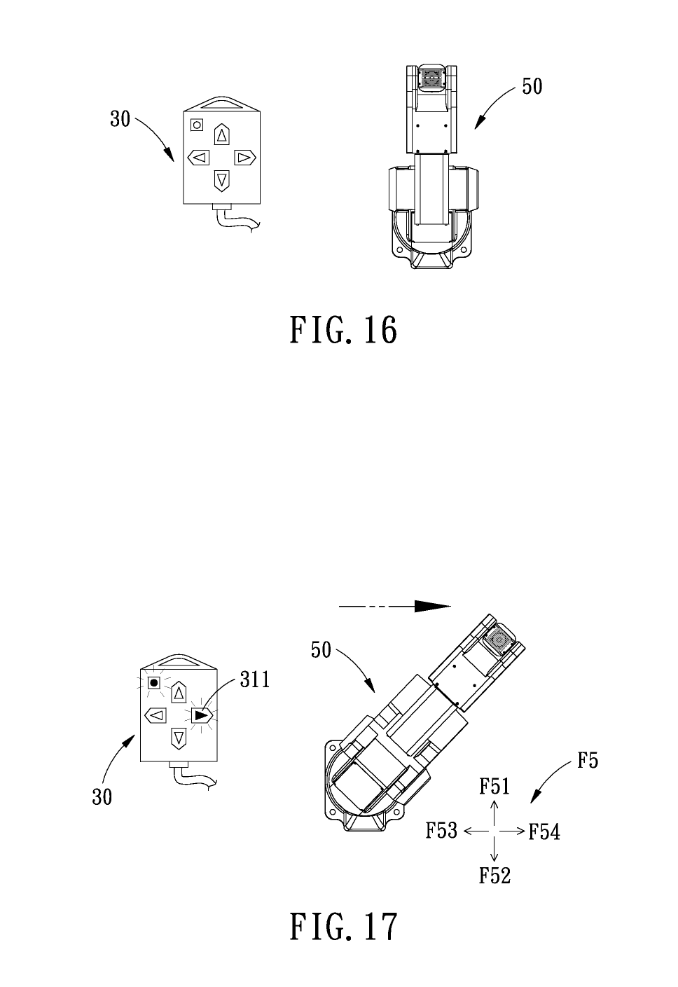

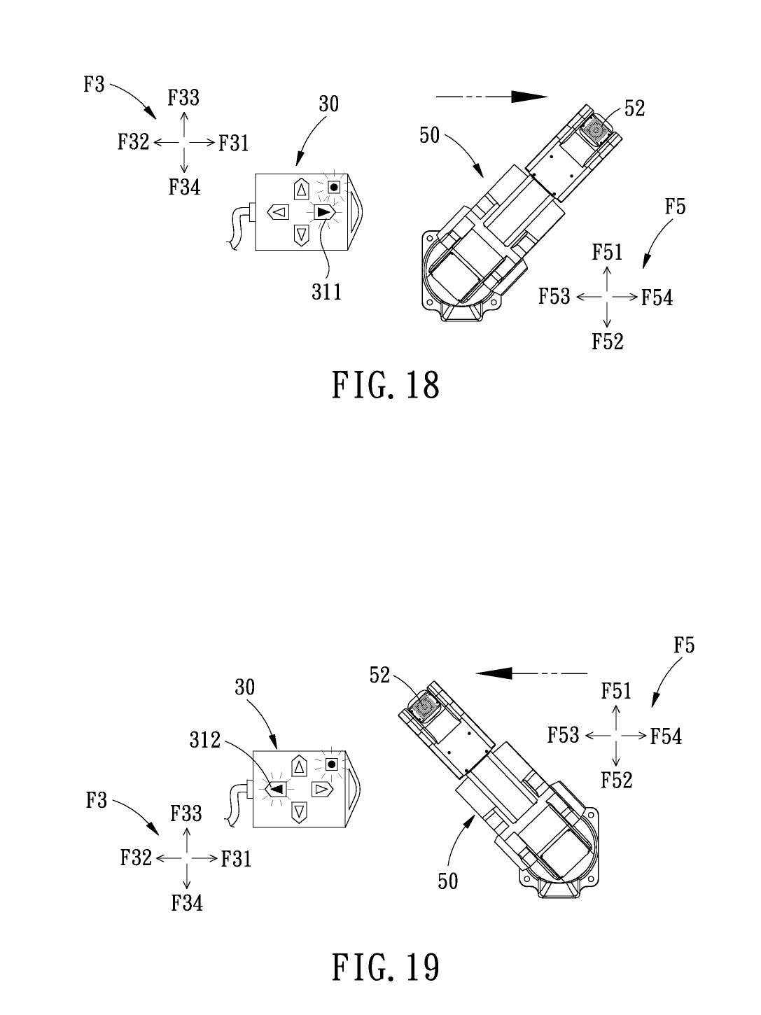

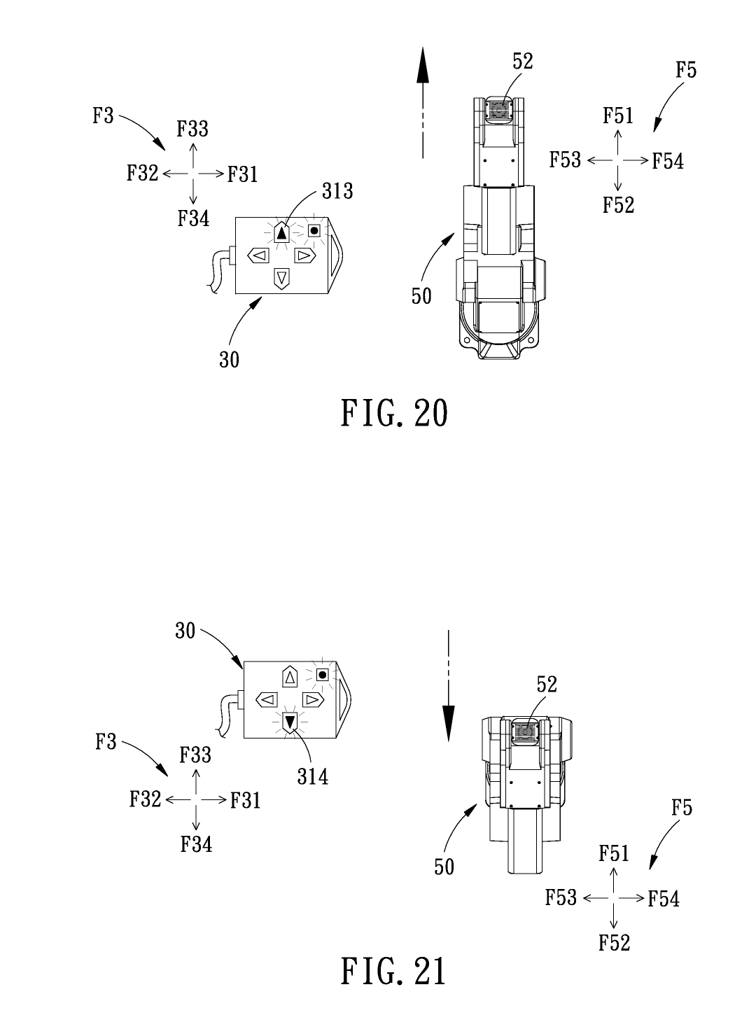

FIGS. 16-21 show the manual directional control mode. FIG. 16 shows the initial stage of the instructor 30 and the robot 50, the operator can select the manual directional control mode by using the directional-control starter 60, then controls the robot 50 by using the control unit 31 of the instructor 30. In this embodiment, the rightward-move button 314 of the control unit 31 is pressed to set the rightward direction F34 as the reference direction of the instructor 30, as shown in FIG. 17, namely, at this moment, the instructor 30 does not have to be provided with the direction detector 32, and the direction reference of the instructor 30 with respect to the robot 50 is manually defined. When the rightward direction F34 of the instructor 30 is manually set as the reference direction, it means that the forward direction F31 of the instructor 30 is adjusted toward the rightward direction F54 of the robot 50, as shown in FIG. 18, so that, when in use, the operator can put the instructor 30 toward the rightward direction F54 of the robot 50. At this moment, pressing the forward-move button 311 of the instructor 30 can make the robot 50 move toward the forward direction F31 of the instructor 30 and the rightward direction F54 of the robot 50, based on the instructor direction reference F3 of the instructor 30. When in the state as shown in FIG. 19, pressing the backward-move button 312 of the instructor 30 can make the robot 50 move toward the backward direction F32 of the instructor 30 and the leftward direction F53 of the robot 50, based on the instructor direction reference F3 of the instructor 30. When in the state as shown in FIG. 20, pressing the leftward-move button 313 of the instructor 30 can make the robot 50 move toward the leftward direction F33 of the instructor 30 and the forward direction F51 of the robot 50, based on the instructor direction reference F3 of the instructor 30. When in the state as shown in FIG. 21, pressing the rightward-move button 314 of the instructor 30 can make the robot 50 move toward the rightward direction F34 of the instructor 30 and the backward direction F52 of the robot 50, based on the instructor direction reference F3 of the instructor 30.

It is learned from the above description that the present invention allows the movement direction reference of the robot 50 to be defined manually or automatically, so that the robot 50 can be moved based on the instructor direction reference F3 of the instructor 30, allowing the operator to operate the robot 50 by intuition without too much discretion, consequently reducing difficulty and error in operating the robot 50. Besides, the operator can control the robot 50 by staying at the location where the instructor 30 is located, without standing close to the robot 50, keeping a safety distance from the robot 50, therefore, improving safety of operating the robot 50.

While we have shown and described various embodiments in accordance with the present invention, it is clear to those skilled in the art that further embodiments may be made without departing from the scope of the present invention.

What is claimed is:

1. A directional position control method using an instructor device and a controller to control motion of a robot, and a directional-control starter being used to actuate a directional control function; wherein
the instructor includes a control unit, the instructor defines an instructor direction reference which synchronously changes along with motion of the instructor;
the controller is signal-connected to the robot, the robot is driven to move by a drive source which is controlled by the controller, at one end of the robot is provided an end effector which is driven to move by a robot;
the directional-control starter allows an operator to start the directional control function and is signal-connected to the instructor and the controller;
the directional position control method comprising the following steps:
starting, the operator uses the directional-control starter to start the directional control function;
giving instruction by operating the control unit of the instructor;
control and motion, the directional-control starter controlling the controller to drive the robot to move according to the instructor direction reference.

2. The directional position control method as claimed in claim 1, wherein the directional-control starter controls the controller to drive the robot to move according to the instructor direction reference by converting the coordinate of the robot into the coordinate of the instructor.

3. The directional position control method as claimed in claim 1, wherein the directional-control starter cooperates with the control unit of the instructor to set the motion direction reference of the robot in a manual control mode.

4. The directional position control method as claimed in claim 1, wherein the instructor includes a direction detector which detects the direction and position of the instructor and detects the instructor direction reference of the instructor, the directional-control starter cooperates with the control unit of the instructor to provide an automatic directional control.

5. The directional position control method as claimed in claim 1, wherein the control unit includes a forward-move button, a backward-move button, a leftward-move button and a rightward-move button.

6. The directional position control method as claimed in claim 1, wherein the control unit is a rocker.

7. The directional position control method as claimed in claim 1, wherein the direction detector is an electronic compass, acceleration sensor or gyroscope.

8. The directional position control method as claimed in claim 1, wherein the directional-control starter is provided on the instructor, the controller or the robot.

9. A directional position control method comprising:
a robot with multiple axles driven by a drive source;
an end effector disposed at one end of the robot and moving along with the movement of the robot;
a controller for controlling the rotation of the drive source of the robot;
a movable instructor having a reference direction and a control unit capable of controlling movement and direction of the robot and moving the end effector to desired positions; and
a directional-control starter capable of actuating a directional control function; the directional position control method being characterized in that:
when the directional control function is actuated, the reference direction of the instructor with respect to the input direction of the control unit is consistent with the reference direction with respect to the direction that the end effector moves.
